(19) United States
(12) Patent Application Publication
(10) Pub. No.: US 2017/0277167 A1
(43) Pub. Date: Sep. 28, 2017

(54) ROBOT SYSTEM, ROBOT CONTROL DEVICE, AND ROBOT

(71) Applicant: Seiko Epson Corporation, Tokyo (JP)

(72) Inventors: Takahiko NODA, Azumino (JP); Takashi NAMMOTO, Azumino (JP)

(21) Appl. No.: 15/464,703

(22) Filed: Mar. 21, 2017

(30) Foreign Application Priority Data
Mar. 24, 2016 (JP) 2016-059673

(51) Int. Cl. G05B 19/408

(52) U.S. Cl. CPC G05B 19/4086

(57) ABSTRACT

A robot system comprising, an imaging unit, a robot, and a robot control device that causes the robot to have a plurality of pieces of conversion information which convert first information which represents a position and posture of a target object in an imaging unit coordinate system representing a position and posture on an image captured by the imaging unit to second information representing a position and posture of the target object in a first coordinate system, to select one conversion information, as a target conversion information, out of the plurality of pieces of conversion information, and to perform a predetermined work based on the selected conversion information.

### BACKGROUND

1. Technical Field

The present invention relates to a robot, a robot control device, and a robot system.

2. Related Art

Research and development on a technique for causing a robot to perform a predetermined work based on an image captured by an imaging unit are underway.

In this regard, a robot operation control device for controlling an operation of the robot by applying a parameter to convert coordinates with respect to a target point is known. The robot operation control device controls the operation of the robot by dividing an operation space for the robot into a plurality of regions, setting a measurement point to derive the parameter for each divided operation space, selecting a parameter for the operation space, to which a target point belongs, out of derived parameters for the operation space, and applying the selected parameter to convert coordinates with respect to the target point (refer to JP-A-2009-148850).

However, in such an operation control device, in a case where an angle of rotation of each joint of the robot is changed without changing a posture of a TCP of the robot with respect to the target point, the position and posture of the TCP after the angle of rotation is changed deviates from the position and posture of the TCP before the angle of rotation is changed due to errors caused by the rigidity of each member which configures the robot, in some cases. As a result, in the operation control device, improving the accuracy of the work performed by the robot is difficult in some cases.

### SUMMARY

An aspect of the invention is directed to a robot that has a plurality of pieces of conversion information which convert first information which represents a position and posture of a target object in an imaging unit coordinate system representing a position and posture on an image captured by an imaging unit to second information representing a position and posture of the target object in a first coordinate system, selects one conversion information, as a target conversion information, out of the plurality of pieces of conversion information, and performs a predetermined work based on the selected conversion information.

In this configuration, the robot has the plurality of pieces of conversion information which convert the first information which represents the position and posture of the target object in the imaging unit coordinate system representing the position and posture on the image captured by the imaging unit to the second information representing the position and posture of the target object in the first coordinate system, selects one conversion information, as the target conversion information, out of the plurality of pieces of conversion information, and performs the predetermined work based on the selected conversion information. Accordingly, the robot can improve the accuracy of the work performed by the robot.

In another aspect of the invention, the robot may be configured such that the conversion information is correlated with position information indicating a position in the imaging unit coordinate system and the conversion information, in which the position indicated by the position information correlated with the conversion information and the position of the target object in the imaging unit coordinate system detected from the captured image are the closest to each other, is selected as the target conversion information.

In this configuration, the robot selects, as the target conversion information, the conversion information, in which the position indicated by the position information correlated with the conversion information and the position of the target object in the imaging unit coordinate system detected from the captured image are the closest to each other. Accordingly, the robot can improve the accuracy of the work performed by the robot based on the conversion information correlated with the position information.

In another aspect of the invention, the robot may be configured such that the conversion information is also correlated with posture information indicating a posture in the imaging unit coordinate system and the conversion information, in which the posture indicated by the posture information correlated with the conversion information and the posture of the target object in the imaging unit coordinate system detected from the captured image are the closest to each other, is selected as the target conversion information.

In this configuration, the conversion information is also correlated with the posture information indicating the posture in the imaging unit coordinate system, and the robot selects, as the target conversion information, the conversion information, in which the posture indicated by the posture information correlated with the conversion information and the posture of the target object in the imaging unit coordinate system detected from the captured image are the closest to each other. Accordingly, the robot can improve the accuracy of the work performed by the robot based on the conversion information correlated with the posture information.

In another aspect of the invention, the robot may be configured such that seven or more joints are provided, the conversion information is also correlated with redundant angle of rotation information indicating a redundant angle of rotation that is an angle of a target plane, which is a plane including a triangle formed by the three swing joints, out of the joints provided in the robot, being connected, with respect to a reference plane, the conversion information, in which the redundant angle of rotation indicated by the redundant angle of rotation information correlated with the conversion information and the redundant angle of rotation input in advance are the closest to each other, is selected as the target conversion information.

In this configuration, the robot selects, as the target conversion information, the conversion information, in which the redundant angle of rotation indicated by the redundant angle of rotation information correlated with the conversion information and the redundant angle of rotation input in advance are the closest to each other. Accordingly, the robot can improve the accuracy of the work performed by the robot based on the conversion information correlated with the redundant angle of rotation information.

In another aspect of the invention, the robot may be configured such that the conversion information is also correlated with pose information indicating, out of two angles of rotation that are different from each other by 180°, one being a smaller angle of rotation and the other being a larger angle of rotation, which angle of rotation is to be set as the angle of rotation of a joint that is capable of being flipped, which is a joint capable of having a position and posture of a control point coincide with a first position and a first posture out of joints provided in the robot even when the angle of rotation thereof is any one of the two angles of rotation different from each other by 180°, and the conversion information, in which the pose information correlated with the conversion information coincides with the pose information input in advance, is selected as the target conversion information.

In this configuration, the robot selects, as the target conversion information, the conversion information, in which the pose information correlated with the conversion information coincides with the pose information input in advance. Accordingly, the robot can improve the accuracy of the work performed by the robot based on the conversion information correlated with the pose information.

In another aspect of the invention, the robot may be configured such that a region in which the robot performs the work is divided into a plurality of regions, and one or more pieces of the conversion information are generated for each of a plurality of measurement points according to the divided regions.

In this configuration, the robot divides the region in which the robot performs the work into the plurality of regions, and generates one or more pieces of the conversion information for each of the plurality of measurement points according to the divided regions. Accordingly, the robot can improve the accuracy of the work performed by the robot based on one or more of the pieces of conversion information generated for each of the plurality of measurement points according to the divided region.

In another aspect of the invention, the robot may be configured such that, for each of the measurement points, processing of generating the conversion information is executed after having a control point of the robot coincide with the measurement point.

In this configuration, the robot executes the processing of generating the conversion information for each of the measurement points after having the control point of the robot coincide with the measurement point. Accordingly, the robot can improve the accuracy of the work performed by the robot based on the conversion information generated by the processing of generating the conversion information, which is processing executed for each measurement point.

In another aspect of the invention, the robot may be configured such that the processing is processing of generating the conversion information each time a posture of the control point in the first coordinate system is changed while maintaining a position of the control point of the robot in the first coordinate system.

In this configuration, the robot executes the processing of generating the conversion information each time the posture of the control point in the first coordinate system is changed while maintaining the position of the control point in the first coordinate system. Accordingly, the robot can improve the accuracy of the work performed by the robot based on the conversion information generated by the processing of generating the conversion information each time the posture of the control point in the first coordinate system is changed for each measurement point while maintaining a state in which the measurement point coincides with the control point of the robot.

In another aspect of the invention, the robot may be configured such that seven or more joints are provided, and the processing is processing of generating the conversion information each time a redundant angle of rotation that is an angle of a target plane is changed, which is a plane including a triangle formed by the three swing joints out of the joints provided in the robot being connected, with respect to a reference plane while maintaining a position of the control point in the first coordinate system.

In this configuration, the robot executes the processing of generating the conversion information each time the redundant angle of rotation that is the angle of the target plane, which is the plane including the triangle formed by the three swing joints out of the joints provided in the robot being connected, with respect to the reference plane while maintaining the position of the control point in the first coordinate system. Accordingly, the robot can improve the accuracy of the work performed by the robot based on the conversion information generated by the processing of generating the conversion information each time the redundant angle of rotation is changed for each measurement point while maintaining the state in which the measurement point coincides with the control point of the robot.

In another aspect of the invention, the robot may be configured such that the processing is processing of generating the conversion information each time an angle of rotation of a joint that is capable of being flipped, out of joints provided in the robot, which is a joint capable of having a position and posture of the control point coincide with a first position and a first posture even when the angle of rotation thereof is anyone of two angles of rotation different from each other by 180°, is changed to any one of the two angles of rotation that are different from each other by 180°, one being a smaller angle of rotation and the other being a larger angle of rotation, while maintaining the position of the control point in the first coordinate system.

In this configuration, the robot executes the processing of generating the conversion information each time the angle of rotation of the joint that is capable of being flipped, out of the joints provided in the robot, which is the joint capable of having the position and posture of the control point coincide with the first position and the first posture even when the angle of rotation thereof is any one of the two angles of rotation different from each other by 180°, is changed to any one of the two angles of rotation that are different from each other by 180°, one being the smaller angle of rotation and the other being the larger angle of rotation. Accordingly, the robot can improve the accuracy of the work performed by the robot based on the conversion information generated by the processing of generating the conversion information each time the angle of rotation of the joint that is capable of being flipped for each measurement point is changed while maintaining the state in which the measurement point coincides with the control point of the robot.

In another aspect of the invention, the robot may be configured such that the conversion information is also correlated with imaging position and posture information indicating an imaging position and posture, which are a position and posture of the imaging unit in the first coordinate system, and the conversion information, in which the imaging position and posture indicted by the imaging position and posture information correlated with the conversion information coincide with the imaging position and posture input in advance, is selected as the target conversion information.

In this configuration, the robot selects, as the target conversion information, the conversion information, in which the imaging position and posture indicated by the imaging position and posture information correlated with the conversion information coincide with the imaging position and posture input in advance. Accordingly, the robot can improve the accuracy of the work performed by the robot based on the conversion information correlated with the imaging position and posture information.

In another aspect of the invention, the robot may be configured such that the first information is a first matrix, the second information is a second matrix, the conversion information is a conversion matrix, and the first coordinate system is a robot coordinate system.

In this configuration, the robot has a plurality of pieces of conversion matrices which converts the first matrix which represents a position and posture of a target object in an imaging unit coordinate system representing a position and posture on an image captured by an imaging unit to a second matrix representing a position and posture of the target object in the robot coordinate system, selects one conversion matrix, as a target conversion matrix, out of the plurality of pieces of conversion matrices, and performs a predetermined work based on the selected conversion matrix. Accordingly, the robot can improve the accuracy of the work performed by the robot.

Another aspect of the invention is directed to a robot control device that causes a robot to have a plurality of pieces of conversion information which convert first information which represents a position and posture of a target object in an imaging unit coordinate system representing a position and posture on an image captured by an imaging unit to second information representing a position and posture of the target object in a first coordinate system, to select one conversion information, as a target conversion information, out of the plurality of pieces of conversion information, and to perform a predetermined work based on the selected conversion information.

In this configuration, the robot control device causes the robot to have the plurality of pieces of conversion information which convert the first information which represents the position and posture of the target object in the imaging unit coordinate system representing the position and posture on the image captured by the imaging unit to second information representing the position and posture of the target object in the first coordinate system, to select one conversion information, as the target conversion information, out of the plurality of pieces of conversion information, and to perform the predetermined work based on the selected conversion information. Accordingly, the robot control device can improve the accuracy of the work performed by the robot.

Another aspect of the invention is directed to a robot system that includes an imaging unit, a robot, and a robot control device that causes the robot to have a plurality of pieces of conversion information which convert first information which represents a position and posture of a target object in an imaging unit coordinate system representing a position and posture on an image captured by the imaging unit to second information representing a position and posture of the target object in a first coordinate system, to select one conversion information, as a target conversion information, out of the plurality of pieces of conversion information, and to perform a predetermined work based on the selected conversion information.

In this configuration, the robot system causes the robot to have the plurality of pieces of conversion information which convert the first information which represents the position and posture of the target object in the imaging unit coordinate system representing the position and posture on the image captured by the imaging unit to the second information representing the position and posture of the target object in the first coordinate system, to select one conversion information, as the target conversion information, out of the plurality of pieces of conversion information, and to perform the predetermined work based on the selected conversion information. Accordingly, the robot system can improve the accuracy of the work performed by the robot.

As described above, the robot has the plurality of pieces of conversion information which convert the first information which represents the position and posture of the target object in the imaging unit coordinate system representing the position and posture on the image captured by the imaging unit to the second information representing the position and posture of the target object in the first coordinate system, selects one conversion information, as the target conversion information, out of the plurality of pieces of conversion information, and performs the predetermined work based on the selected conversion information. Accordingly, the robot can improve the accuracy of the work performed by the robot.

In addition, the robot control device and the robot system cause the robot to have the plurality of pieces of conversion information which convert the first information which represents the position and posture of the target object in the imaging unit coordinate system representing the position and posture on the image captured by the imaging unit to the second information representing the position and posture of the target object in the first coordinate system, to select one conversion information, as the target conversion information, out of the plurality of pieces of conversion information, and to perform the predetermined work based on the selected conversion information. Accordingly, the robot control device and the robot system can improve the accuracy of the work performed by the robot.

### BRIEF DESCRIPTION OF THE DRAWINGS

The invention will be described with reference to the accompanying drawings, wherein like numbers reference like elements.

FIG. 1 is a view illustrating an example of a configuration of a robot system according to an embodiment.

FIG. 2 is a view illustrating an example of a hardware configuration of a robot control device.

FIG. 3 is a view illustrating an example of a functional configuration of the robot control device.

FIG. 4 is a flow chart illustrating an example of a flow of processing in which the robot control device selects a conversion matrix that satisfies a predetermined condition as a target conversion matrix out of a plurality of conversion matrices.

FIG. 5 is a view illustrating an example of a conversion matrix table.

FIG. 6 is a flow chart illustrating an example of a flow of processing in which the robot control device generates a conversion matrix.

FIG. 7 is a view exemplifying a work region divided into a plurality of regions and a measurement point.

FIG. 8 is a view illustrating another example of the conversion matrix table.

FIG. 9 is a view illustrating an example of the conversion matrix table storing a plurality of first matrices and second matrices correlated with redundant angle of rotation information and pose information.

### DESCRIPTION OF EXEMPLARY EMBODIMENTS

### Embodiment

Hereinafter, an embodiment of the invention will be described with reference to the drawings.

### Configuration of Robot System

First, a configuration of a robot system 1 will be described.

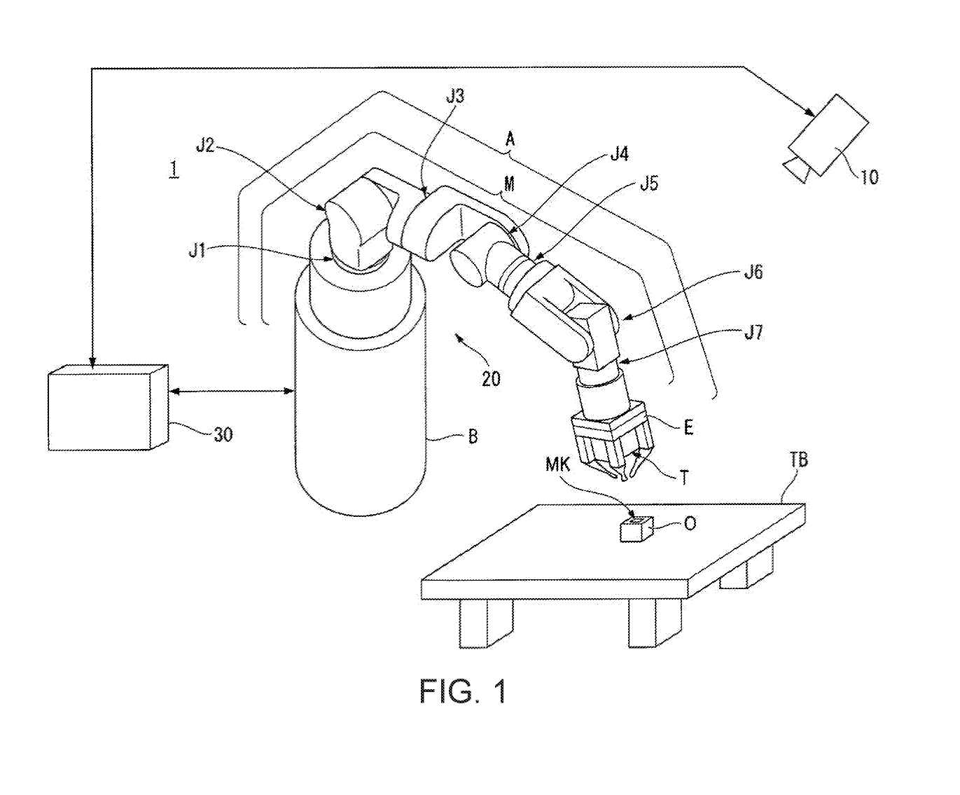

FIG. 1 is a view illustrating an example of the configuration of the robot system 1 according to the embodiment. The robot system 1 is provided with an imaging unit 10, a robot 20, and a robot control device 30.

The imaging unit 10 is, for example, a camera provided with a charge coupled device (CCD) or a complementary metal oxide semiconductor (CMOS) that is an imaging element which converts condensed light into an electrical signal. In this example, the imaging unit 10 is provided at a position where an area that includes a work region RA in which the robot 20 performs a work can be imaged.

The imaging unit 10 is connected to the robot control device 30 via a cable so as to be capable of communicating with the robot control device 30. Wired communication via the cable is, for example, carried out in accordance with standards including Ethernet (registered trademark) and Universal Serial Bus (USB). The imaging unit 10 may be configured to be connected to the robot control device 30 by wireless communication carried out in accordance with communication standards including Wi-Fi (registered trademark).

The robot 20 is a one-armed robot provided with an arm A and a support base B that supports the arm A. The one-armed robot is a robot provided with one arm such as the arm A in this example. Instead of the one-armed robot, the robot 20 may be a multi-armed robot. The multi-armed robot is a robot provided with two or more arms (for example, two or more arms A). Out of multi-armed robots, a robot provided with two arms is referred to as a two-armed robot. That is, the robot 20 may be the two-armed robot provided with two arms, and may be the multi-armed robot provided with three or more arms (for example, three or more arms A). In addition, the robot 20 may be other robots including a SCARA and a cartesian coordinate robot. The cartesian coordinate robot is, for example, a gantry robot.

The arm A is provided with an end effector E and a manipulator M.

In this example, the end effector E is an end effector provided with a finger portion that is capable of gripping an object. Instead of the end effector provided with the finger portion, the end effector E may be an end effector that is capable of lifting up an object by means of air suction, magnetic force, and a jig, or other end effectors.

The end effector E is connected to the robot control device 30 via a cable so as to be capable of communicating with the robot control device 30. Accordingly, the end effector E operates based on a control signal acquired from the robot control device 30. Wired communication via the cable is, for example, carried out in accordance with standards including Ethernet (registered trademark) and USB. In addition, the end effector E may be configured to be connected to the robot control device 30 by wireless communication carried out in accordance with communication standards including Wi-Fi (registered trademark).

The manipulator M is provided with seven joints, including a joint J1 to a joint J7. In addition, each of the joint J1 to the joint J7 is provided with an actuator (not illustrated). That is, the armA provided with the manipulator M is a seven-axis vertical multi-joint arm. The arm A operates with seven-axis degree of freedom by the support base B, the end effector E, the manipulator M, and each actuator of the seven joints provided in the manipulator M being operated in cooperation with each other. The arm A may be configured to operate with six or less-axis degree of freedom, or may be configured to operate with eight or more-axis degree of freedom.

In a case where the arm A operates with seven-axis degree of freedom, the number of postures the arm A can take increases compared to a case where the arm A operates with six or less-axis degree of freedom. Accordingly, for example, the motion of the arm A becomes smooth, and the arm A can easily avoid interference with an object that exists in the vicinity of the arm A. In addition, in a case where the arm A operates with seven-axis degree of freedom, the arm A is easily controlled since calculation is less required compared to a case where the arm A operates with eight or more-axis degree of freedom.

In this example, each of the joint J1, the joint J3, the joint J5, and the joint J7 is a rotary joint. The rotary joint is a joint that does not change an angle between two links connected to a rotary shaft in response to the rotation of the rotary shaft. The link is a member that is provided in the manipulator M and links the joints. In addition, each of the joint J2, the joint J4, and the joint J6 is a swing joint. The swing joint is a joint that changes an angle between two links connected to the rotary shaft in response to the rotation of the rotary shaft.

Each of the seven actuators (provided in the joints) provided in the manipulator M is connected to the robot control device 30 via a cable so as to be capable of communicating with the robot control device 30. Accordingly, the actuators operate the manipulator M based on a control signal acquired from the robot control device 30. In addition, each actuator is provided with an encoder. Each encoder outputs information indicating an angle of rotation of the actuator provided with each encoder to the robot control device 30. Wired communication via the cable is, for example, carried out in accordance with standards including Ethernet (registered trademark) and USB. In addition, a part of or the whole of the seven actuators provided in the manipulator M may be configured to be connected to the robot control device 30 by wireless communication carried out in accordance with communication standards including Wi-Fi (registered trademark).

In this example, the robot control device 30 is a robot controller. The robot control device 30 generates a control signal for operating the robot 20 based on an operation program input by a user in advance. The robot control device 30 outputs the generated control signal to the robot 20, and causes the robot 20 to perform a predetermined work.

### Predetermined Work Performed by Robot

Hereinafter, a predetermined work performed by the robot 20 will be described. In an example illustrated in FIG. 1, an object O is placed on the upper surface of a working base TB. The working base TB is, for example, a table. Instead of the table, the working base TB may be any object, including a floor and a shelf, insofar as the object O can be placed.

The object O is, for example, an industrial component or member and product. Instead of the aforementioned objects, the object O may be other objects, including a non-industrial component or member and product for daily necessities and a living body. In the example illustrated in FIG. 1, the object O is illustrated as a rectangular parallelepiped object. Instead of a rectangular parallelepiped shape, the shape of the object O may be other shapes. Out of surfaces of the object O, a marker MK is provided on a surface opposite to a surface with which the upper surface of the working base TB is in contact. The marker MK is a marker indicating the position and posture of the centroid of the object O in a robot coordinate system RC. In FIG. 1, the marker MK is illustrated as a rectangular mark on the surface of the object O. Instead of the aforementioned maker, the marker MK may be apart of the object O, which indicates the position and posture. In addition, instead of a rectangular shape, the shape of the marker MK may be other shapes.

The robot 20 performs a work of gripping the object O by means of the end effector E and disposing the gripped object in a predetermined material supplying region (not illustrated) as a predetermined work. Instead of the aforementioned work, the predetermined work may be other works.

### Outline of Processing Performed by Robot Control Device

Hereinafter, an outline of processing performed by the robot control device 30 will be described.

The robot control device 30 sets a control point T, which moves along with the end effector E, at a position correlated in advance with the end effector E. The position correlated in advance with the end effector E is, for example, the position of the centroid of the end effector E. The control point T is, for example, a tool center point (TCP). Instead of the TCP, the control point T may be other virtual points including a virtual point correlated with a part of the manipulator M. That is, instead of the position correlated with the end effector E, the control point T may be configured to be set at positions of other parts of the end effector E, or may be configured to be set at any positions correlated with the manipulator M.

Regarding the control point T, control point position information, which is information indicating the position of the control point T, is correlated with control point posture information, which is information indicating the posture of the control point T. In addition to the aforementioned information, the control point T may be configured such that other pieces of information are correlated with each other regarding the control point T. Once the robot control device 30 designates (determines) control point position information and control point posture information, the position and posture of the control point T are determined. The position and posture of the control point T are a position and posture in the robot coordinate system RC. The robot control device 30 designates control point position information and control point posture information. The robot control device 30 operates the arm A. In addition, the robot control device 30 has the position of the control point T coincide with the position that is indicated by the control point position information designated by the robot control device 30 and has the posture of the control point T coincide with the posture that is indicated by the control point posture information designated by the robot control device 30. Hereinafter, for the convenience of description, the position that is indicated by the control point position information designated by the robot control device 30 will be referred to as a target position, and the posture that is indicated by the control point posture information designated by the robot control device 30 will be referred to as a target posture. That is, the robot control device 30 operates the robot 20 by designating control point position information and control point posture information, and has the position and posture of the control point T coincide with the target position and the target posture.

In this example, the position of the control point T is represented by a position in the robot coordinate system RC, which is the original of a control point coordinate system TC. In addition, the posture of the control point T is represented by a direction in the robot coordinate system. RC, which is each coordinate axis of the control point coordinate system TC. The control point coordinate system TC is a three-dimensional local coordinate system, which is correlated with the control point T such that the control point coordinate system TC moves along with the control point T.

The robot control device 30 sets the control point T based on control point setting information input in advance by the user. The control point setting information is, for example, information indicating a relative position and posture between the position and posture of the centroid of the end effector E and the position and posture of the control point T. Instead of the aforementioned information, the control point setting information may be information indicating a relative position and posture between any position and posture correlated with the end effector E and the position and posture of the control point T, or may be information indicating a relative position and posture between any position and posture correlated with the manipulator M and the position and posture of the control point T, or may be information indicating a relative position and posture between any position and posture correlated with other parts of the robot 20 and the position and posture of the control point T.

The robot control device 30 causes the imaging unit 10 to image an area that includes the work region RA. The robot control device 30 acquires the image captured by the imaging unit 10. Based on the captured image acquired from the imaging unit 10, the robot control device 30 detects the position and posture of a target object included in the captured image. The position and posture are the position and posture of the target object in an imaging unit coordinate system CC. The target object is, for example, a part of or the whole of the end effector E, a part of or the whole of the manipulator M, and an object other than the robot 20. Hereinafter, a case where the target object is the object O illustrated in FIG. 1 will be described as an example. The imaging unit coordinate system CC is a three-dimensional local coordinate system representing a position and posture on the image captured by the imaging unit 10.

That is, the robot control device 30 detects the position and posture of the object O in the imaging unit coordinate system CC from the captured image acquired from the imaging unit 10. The position and posture of the object O are the position and posture correlated with the object O. Hereinafter, a case where the position and posture of the object O are represented by a gripped position and gripped posture input by the user in advance will be described as an example. The gripped position and the gripped posture are a target position and posture with which the robot control device 30 has the position and posture of the control point T coincide immediately before the end effector E grips the object O. Instead of the gripped position and the gripped posture, the position and posture of the object O may be configured to be represented by other positions and postures correlated with the object O.

More specifically, the robot control device 30 detects the marker MK from the captured image acquired from the imaging unit 10. The robot control device 30 detects the position and posture of the centroid of the object O in the imaging unit coordinate system CC based on the detected marker MK. Then, the robot control device 30 detects the position and posture of the object O in the imaging unit coordinate system CC based on the detected position and posture and gripped position and posture information input in advance by the user. The gripped position and posture information is information indicating the aforementioned gripped position and gripped posture as a relative position and posture with respect to the position and posture of the centroid of the object O. The robot control device 30 may be configured to detect the position and posture of the centroid of the object O in the imaging unit coordinate system CC from the captured image, for example, by pattern matching.

The robot control device 30 calculates first information indicating the position and posture of the object O based on the position and posture of the object O in the imaging unit coordinate system CC detected from the captured image acquired from the imaging unit 10. The robot control device converts the calculated first information to second information indicating the position and posture of the object O in a first coordinate system. The robot control device 30 designates information indicating the position indicated by the converted second information as the control point position information, and designates information indicating the posture indicated by the converted second information as the control point posture information. Based on the designated control point position information and control point posture information, the robot control device 30 generates a control signal for rotating each joint of the manipulator M such that the position and posture of the control point T in the first coordinate system change into the target position and target posture in the first coordinate system. The robot control device 30 outputs the generated control signal to the robot 20, and has the position and posture of the control point T in the first coordinate system coincide with the gripped position and the gripped posture, which are the target position and target posture in the first coordinate system. Then, the robot control device 30 causes the end effector E to grip the object O. The robot control device 30 disposes the object O gripped by the end effector E in the material supplying region (not illustrated) based on information indicating the position of the material supplying region input in advance by the user. In this way, the robot control device 30 causes the robot 20 to perform a predetermined work.

Hereinafter, a case where the first information is a first matrix ^{C}T_{TCP} will be described as an example. In this case, the second information is a second matrix ^{R}T_{TCP}. Instead of the first matrix ^{C}T_{TCP}, the first information may be a database that includes information indicating each element of the first matrix ^{C}T_{TCP}, or may be other information including information indicating a plurality of equations representing the information. In this case, the second information may be information that depends on the first information. In addition, hereinafter, a case where the first coordinate system is the robot coordinate system RC will be described as an example. Instead of the robot coordinate system RC, the first coordinate system may be other coordinate systems including a world coordinate system.

That is, based on the position and posture of the object O in the imaging unit coordinate system CC detected from the captured image acquired from the imaging unit 10, the robot control device 30 calculates the first matrix ^{C}T_{TCP} representing the position and posture of the object O. The robot control device 30 converts the calculated first matrix ^{C}T_{TCP} to the second matrix ^{R}T_{TCP} representing the position and posture of the object O in the robot coordinate system RC. The robot control device 30 designates information indicating the position represented by the converted second matrix ^{R}T_{TCP} as the control point position information, and designates information indicating the posture represented by the converted second matrix ^{R}T_{TCP} as the control point posture information. Based on the designated control point position information and control point posture information, the robot control device 30 generates a control signal for rotating each joint of the manipulator M such that the position and posture of the control point T in the robot coordinate system RC change into the target position and target posture in the robot coordinate system RC. The robot control device 30 outputs the generated control signal to the robot 20, and has the position and posture of the control point T in the robot coordinate system RC coincide with the gripped position and gripped posture, which are the target position and target posture in the robot coordinate system RC. Then, the robot control device 30 causes the end effector E to grip the object O. The robot control device 30 disposes the object O gripped by the end effector E in the material supplying region (not illustrated) based on the information indicating the position of the material supplying region input in advance by the user. In this way, the robot control device 30 causes the robot 20 to perform a predetermined work.

Conversion information for converting the first matrix ^{C}T_{TCP} to the second matrix ^{R}T_{TCP} is stored in advance in the robot control device 30 when the robot control device 30 converts the first matrix ^{C}T_{TCP} to the second matrix ^{R}T_{TCP}. The robot control device 30 selects a piece of conversion information as target conversion information out of a plurality of pieces of conversion information, and converts the first matrix ^{C}T_{TCP} to the second matrix ^{R}T_{TCP} based on the selected target conversion information. Accordingly, the robot control device 30 causes the robot 20 to perform a predetermined work.

Hereinafter, a case where the conversion information is a conversion matrix ^{R}T_{C} will be described as an example. Instead of the aforementioned information, the conversion information may be other information including a database that includes information representing each element of the conversion matrix ^{R}T_{C} or may be information indicating a plurality of equations representing the information.

That is, the conversion matrix ^{R}T_{C} for converting the first matrix ^{C}T_{TCP} to the second matrix ^{R}T_{TCP} is stored in advance in the robot control device 30 when the robot control device 30 converts the first matrix ^{C}T_{TCP} to the second matrix ^{R}T_{TCP}. The robot control device 30 selects one conversion matrix ^{R}T_{C} as a target conversion matrix ^{R}T_{C} out of a plurality of conversion matrices ^{R}T_{C}, and converts the first matrix ^{C}T_{TCP} to the second matrix ^{R}T_{TCP} based on the selected target conversion matrix ^{R}T_{C}. Accordingly, the robot control device 30 causes the robot 20 to perform a predetermined work. Hereinafter, processing in which the robot control device 30 selects one conversion matrix ^{R}T_{C} out of the plurality of conversion matrices ^{R}T_{C} as the target conversion matrix ^{R}T_{C} will be described in detail. In addition, hereinafter, processing in which the robot control device 30 generates the plurality of conversion matrices ^{R}T_{C} will be described in detail.

Herein, a relationship among the conversion matrix ^{R}T_{C}, the first matrix ^{C}T_{TCP}, and the second matrix ^{R}T_{TCP} is expressed as the following Expression (1) and Expression (2).

^{R}T_{C}=^{R}T_{TCP}^{C}T_{TCP}⁻¹ (1)

^{C}T_{TCP}⁻¹=^{TCP}T_{C} (2)

The above Expression (2) represents the first matrix ^{C}T_{TCP}, which is an inverse matrix. Hereinafter, for the convenience of description, the first matrix ^{C}T_{TCP} will be simply referred to as a first matrix, the second matrix ^{R}T_{TCP} will be simply referred to as a second matrix, and the conversion matrix ^{R}T_{C} will be simply referred to as a conversion matrix.

### Hardware Configuration of Robot Control Device

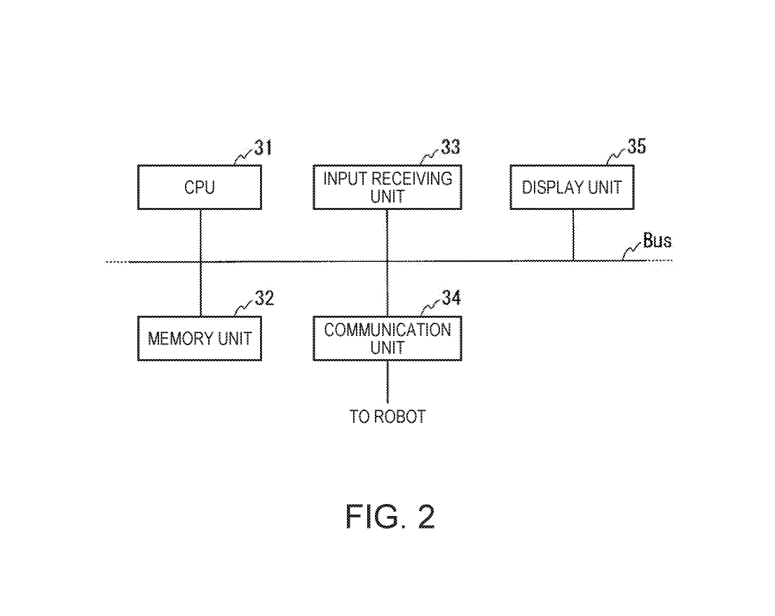

Hereinafter, a hardware configuration of the robot control device 30 will be described with reference to FIG. 2. FIG. 2 is a view illustrating an example of the hardware configuration of the robot control device 30.

The robot control device 30 is provided with, for example, a central processing unit (CPU) 31, a memory unit 32, an input receiving unit 33, a communication unit 34, and a display unit 35. In addition, the robot control device 30 communicates with the robot 20 via the communication unit 34. The aforementioned configuration elements are connected so as to be capable of communicating with each other via a busBUS.

The CPU 31 executes various programs stored in the memory unit 32.

The memory unit 32 is provided with, for example, a hard disk drive (HDD) or a solid state drive (SSD), an electrically erasable programmable read-only memory (EEPROM), a read-only memory (ROM), and a random access memory (RAM). Instead of being mounted in the robot control device 30, the memory unit 32 may be an external type memory device connected by a digital input and output port such as a USB. The memory unit 32 stores various types of information and images processed by the robot control device 30, various programs including an operation program, the aforementioned gripped position and posture information, and a conversion matrix table. The conversion matrix table is a table in which each of the aforementioned plurality of conversion matrices is stored.

The input receiving unit 33 is, for example, a touch panel configured to be integrated with the display unit 35. The input receiving unit 33 may be other input devices including a keyboard, a mouse, and a touchpad.

The communication unit 34 is configured to include, for example, a digital input and output port such as a USB and an Ethernet (registered trademark) port.

The display unit 35 is, for example, a liquid crystal display panel or an organic electroluminescent (EL) display panel.

### Functional Configuration of Robot Control Device

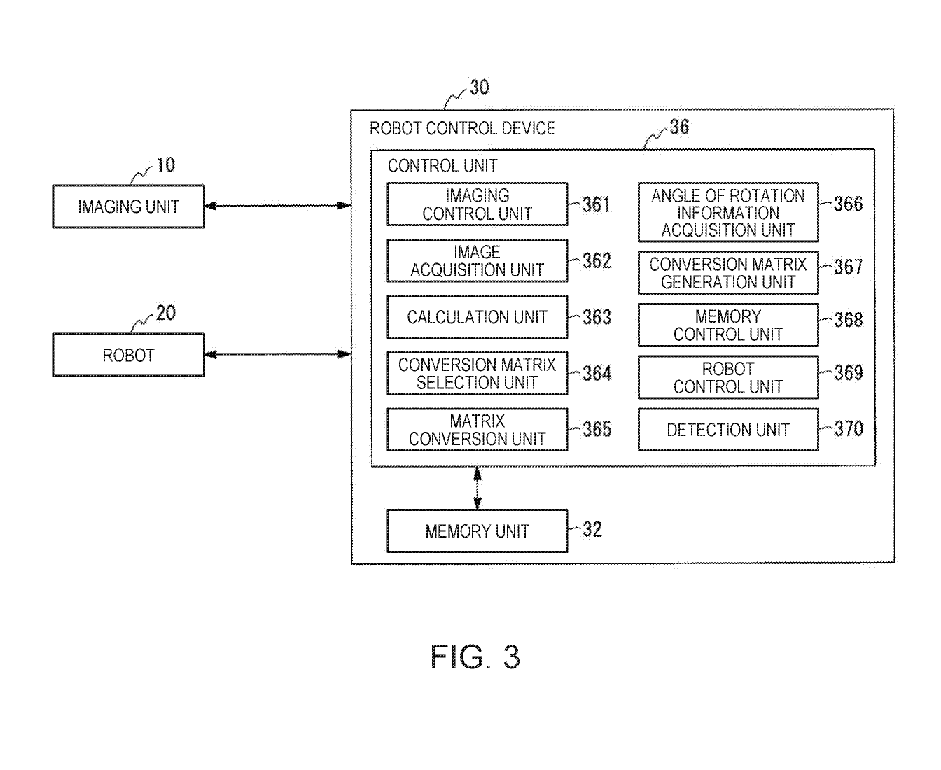

Hereinafter, a functional configuration of the robot control device 30 will be described with reference to FIG. 3. FIG. 3 is a view illustrating an example of the functional configuration of the robot control device 30.

The robot control device 30 is provided with the memory unit 32 and a control unit 36.

The control unit 36 controls the entire robot control device 30. The control unit 36 is provided with an imaging control unit 361, an image acquisition unit 362, a calculation unit 363, a conversion matrix selection unit 364, a matrix conversion unit 365, an angle of rotation information acquisition unit 366, a conversion matrix generation unit 367, a memory control unit 368, a robot control unit 369, and a detection unit 370. The functions of the aforementioned functional units included in the control unit 36 are realized, for example, by various programs stored in the memory unit 32 being executed by the CPU 31. In addition, a part or the whole of the functional units may be a hardware functional unit such as large scale integration (LSI) and application specific integrated circuit (ASIC).

The imaging control unit 361 causes the imaging unit 10 to image an area that includes the work region RA.

The image acquisition unit 362 acquires, from the imaging unit 10, the image captured by the imaging unit 10.

The calculation unit 363 calculates a first matrix representing the position and posture of the object O detected by the detection unit 370 from the captured image acquired by the image acquisition unit 362. The position and posture of the object O are a position and posture in the imaging unit coordinate system CC. In addition, the calculation unit 363 calculates a first matrix representing the position and posture of the control point T detected by the detection unit 370. The position and posture of the control point T are a position and posture in the imaging unit coordinate system CC. In addition, the calculation unit 363 calculates the position and posture of the control point T based on angle of rotation information acquired by the angle of rotation information acquisition unit 366 and forward kinematics. The calculation unit 363 calculates a second matrix representing the calculated the position and posture. The position and posture of the control point T are a position and posture in the robot coordinate system RC.

The conversion matrix selection unit 364 reads the conversion matrix table stored in the memory unit 32. The conversion matrix selection unit 364 selects a conversion matrix that satisfies a predetermined condition out of the plurality of conversion matrices stored in the read conversion matrix table as the target conversion matrix.

The matrix conversion unit 365 converts the first matrix calculated by the calculation unit 363 to the second matrix based on the target conversion matrix selected by the conversion matrix selection unit 364.

The angle of rotation information acquisition unit 366 acquires angle of rotation information indicating the angle of rotation of the actuator provided in each joint of the manipulator M from the encoder provided in each of the actuators.

The conversion matrix generation unit 367 generates a conversion matrix based on the first matrix and second matrix calculated by the calculation unit 363. The first matrix is a first matrix representing the position and posture of the control point T in the imaging unit coordinate system CC. The second matrix is a second matrix representing the position and posture of the control point T in the robot coordinate system RC.

The memory control unit 368 generates a conversion matrix table within a memory region of the memory unit 32. The memory control unit 368 stores the conversion matrix generated by the conversion matrix generation unit 367 in the conversion matrix table generated within the memory region.

The robot control unit 369 operates the robot 20 based on the position and posture represented by the second matrix converted by the matrix conversion unit 365 to cause the robot 20 to perform a predetermined work.

The detection unit 370 detects the position and posture of the object O in the imaging unit coordinate system CC from the captured image acquired by the image acquisition unit 362. In addition, the detection unit 370 detects the position and posture of the control point T in the imaging unit coordinate system CC from the captured image acquired by the image acquisition unit 362.

Processing in which Robot Control Device Selects Conversion Matrix

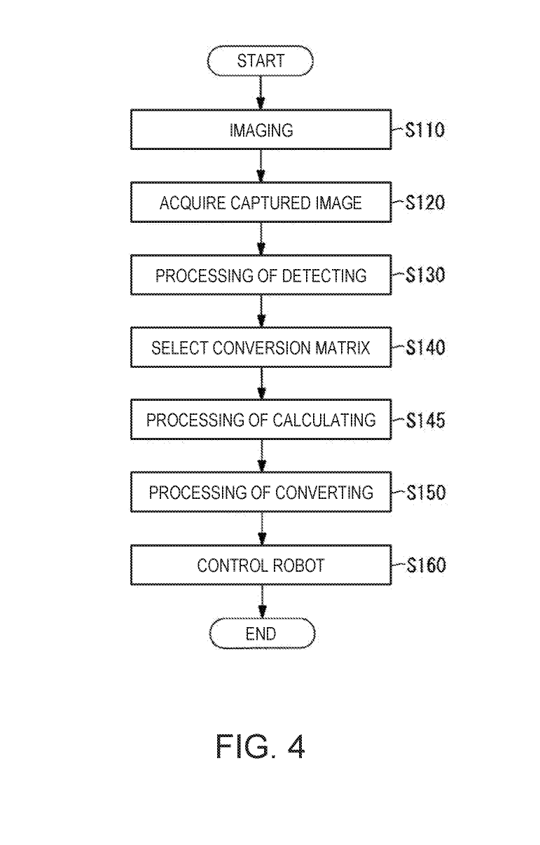

Hereinafter, processing in which the robot control device 30 selects a conversion matrix that satisfies a predetermined condition as the target conversion matrix out of the plurality of conversion matrices will be described with reference to FIG. 4. FIG. 4 is a flow chart illustrating an example of a flow of the processing in which the robot control device 30 selects the conversion matrix that satisfies the predetermined condition as the target conversion matrix out of the plurality of conversion matrices. In the processing of the flow chart illustrated in FIG. 4, a case where the conversion matrix table in which the plurality of conversion matrices are stored in advance in the memory unit 32 will be described.

The imaging control unit 361 causes the imaging unit 10 to image an area that includes the work region RA (Step S110). Next, the image acquisition unit 362 acquires the image captured by the imaging unit 10 in Step S110 from the imaging unit 10 (Step S120).

Next, the detection unit 370 executes processing of detecting the position and posture of the object O included in the captured image acquired by the image acquisition unit 362 in Step S120 (Step S130). The position and posture of the object O are a position and posture in the imaging unit coordinate system CC. For example, the detection unit 370 detects the marker MK provided on the object O. The detection unit 370 detects the position and posture indicated by the detected marker MK. The position and posture are the position and posture of the centroid of the object O in the imaging unit coordinate system CC. The detection unit 370 reads the gripped position and posture information stored in advance in the memory unit 32. The detection unit 370 detects the position and posture of the object O based on the read gripped position and posture information and the position and posture indicated by the detected marker MK.

Instead of the configuration in which the position and posture of the centroid of the object O in the imaging unit coordinate system CC are detected by means of the marker MK, the detection unit 370 may have a configuration in which the position and posture are detected from the captured image by other methods including pattern matching. In a case where the position and posture are detected by pattern matching, the detection unit 370 detects the position and posture from the captured image by pattern matching based on a reference model of the object O stored in advance in the memory unit 32. The reference model of the object O is three-dimensional model data obtained by the three-dimensional shape, color, and pattern of the object O being modeled in three dimensions, and shown, for example, in computer graphics (CG).

Next, the conversion matrix selection unit 364 selects a conversion matrix that satisfies a predetermined condition as the target conversion matrix from the conversion matrix table stored in advance in the memory unit 32 (Step S140). Herein, processing of Step S140 will be described. The conversion matrix selection unit 364 reads redundant angle of rotation information and pose information stored in advance in the memory unit 32.

The redundant angle of rotation information is information indicating a redundant angle of rotation (redundant degree of freedom). In this example, the redundant angle of rotation is the angle of a target plane with respect to a reference plane. The target plane is a plane that includes a triangle formed by each of the joint J2, the joint J4, and the joint J6, out of the joints provided in the manipulator M, being connected by a straight line in a case where a position and posture XX, which are a certain position and posture, coincide with the position and posture of the control point T. More specifically, for example, the target plane is a plane that includes a triangle formed by each of the position of the centroid of the joint J2, the position of the centroid of the joint J4, and the position of the centroid of the joint J6, out of the joints provided in the arm A, being connected by a straight line. Instead of the aforementioned plane, the target plane may be a plane that includes a triangle formed by each of the other position of the joint J2, the other position of the joint J4, and the other position of the joint J6 being connected by a straight line. The reference plane is a plane that includes a triangle formed by each of the joint J2, the joint J4, and the joint J6, out of the joints provided in the arm, being connected by a straight line in a case where the position and posture of the control point of the arm provided with the six joints, including the joint J1, the joint J2, the joint J4, the joint J5, the joint J6, and the joint J7, coincide with the aforementioned position and posture XX. More specifically, for example, the reference plane is a plane that includes a triangle formed by the position of the centroid of the joint J2, the position of the centroid of the joint J4, and the position of the centroid of the joint J6, out of the joints provided in the arm, being connected by a straight line. Instead of the aforementioned plane, the reference plane may be a plane that includes a triangle formed by the other position of the joint J2, the other position of the joint J4, and the other position of the joint J6, out of the joints provided in the arm, being connected by a straight line.

Since the manipulator M is provided with the seven joints from the joint J1 to the joint J7, the angle of the target plane with respect to the reference plane can be changed without changing the position and posture of the control point T in a case where the position and posture XX coincide with the position and posture of the control point T.

The pose information is information in which anyone of two angles of rotation that are different from each other by 180°, one being a smaller angle of rotation and the other being a larger angle of rotation, is designated as the angle of rotation of a joint that is capable of being flipped among the joints of the manipulator M. The joint that is capable of being flipped is a joint that can have the position and posture of the control point T coincide with a first position and a first posture even when any one of the two angles of rotation that are different from each other by 180° is the angle of rotation of each joint of the manipulator M. The first position is a position desired by the user. The first position is a position in the robot coordinate system RC. The first posture is a posture desired by the user. The first posture is a posture in the robot coordinate system RC. In this example, each of the three joints including the joint J2, the joint J4, and the joint J6 is the joint that is capable of being flipped.

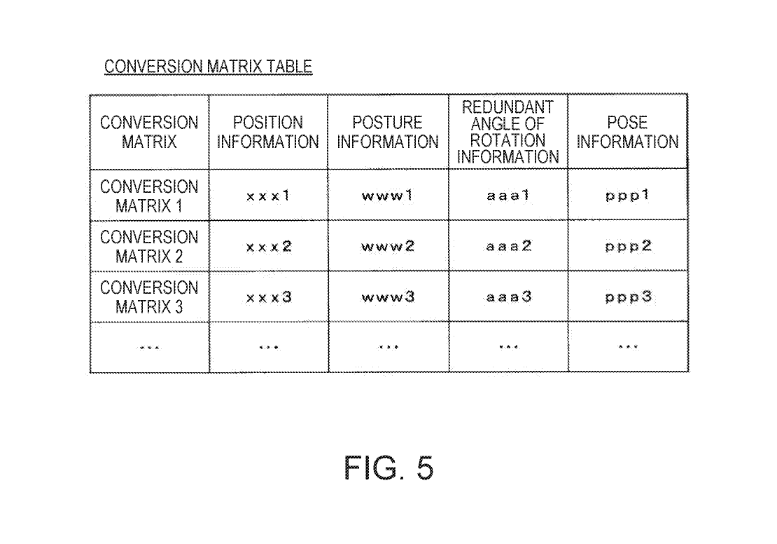

In addition, the conversion matrix selection unit 364 reads, from the memory unit 32, the conversion matrix table stored in advance in the memory unit 32. Herein, the conversion matrix table will be described with reference to FIG. 5. FIG. 5 is a view illustrating an example of the conversion matrix table. As illustrated in FIG. 5, a plurality of conversion matrices are stored in the conversion matrix table by being correlated with position information indicating a position, posture information indicating a posture, redundant angle of rotation information, and pose information. Within the conversion matrix table, the plurality of conversion matrices are different from each other in terms of at least one of the position indicated by the position information, the posture indicated by the posture information, the redundant angle of rotation indicated by the redundant angle of rotation information, and the pose information, which are correlated with the conversion matrix. The conversion matrix table may be configured to store a conversion matrix with which a part of the position information, the posture information, the redundant angle of rotation information, and the pose information are correlated. In addition, instead of a part of or the whole of the position information, the posture information, the redundant angle of rotation information, and the pose information, the conversion matrix table may be configured to store a conversion matrix with which other types of information are correlated.

The conversion matrix selection unit 364 selects one conversion matrix that satisfies a predetermined condition from the conversion matrix table read from the memory unit 32 as the target conversion matrix. The predetermined condition, in this example, is satisfying all of four conditions 1) to 4) in the followings. The predetermined condition may have a configuration in which a part of the four conditions is required to be satisfied, or may have a configuration in which other conditions are required to be satisfied instead of apart of or the whole of the four conditions.

1) A conversion matrix correlated with position information indicating a position which is the closest to the position of the object O detected in Step S130 by the detection unit 370. The position is a position in the imaging unit coordinate system CC.

2) A conversion matrix correlated with posture information indicating a posture which is the closest to the posture of the object O detected in Step S130 by the detection unit 370. The posture is a posture in the imaging unit coordinate system CC.

3) A conversion matrix correlated with redundant angle of rotation information indicating a redundant angle of rotation which is the closest to the redundant angle of rotation indicated by the redundant angle of rotation information stored in advance in the memory unit 32, that is, the redundant angle of rotation information input in advance by the user.

4) A conversion matrix correlated with pose information that coincides with the pose information stored in advance in the memory unit 32, that is, the pose information input in advance by the user.

The conversion matrix selection unit 364 calculates a distance between the position of the object O detected in Step S130 by the detection unit 370, which is a position in the imaging unit coordinate system CC, and the position indicated by the position information correlated with each conversion matrix. The conversion matrix selection unit 364 identifies, out of the position information, position information indicating a position from which a calculated distance is the shortest. The conversion matrix selection unit 364 identifies a conversion matrix correlated with the identified position information as a conversion matrix that satisfies the above condition 1).

In addition, the conversion matrix selection unit 364 calculates a deviation between the posture of the object O detected in Step S130 by the detection unit 370, which is a posture in the imaging unit coordinate system CC, and the posture indicated by the posture information correlated with each conversion matrix. The conversion matrix selection unit 364 identifies, out of the posture information, posture information indicating a posture in which the calculated deviation is the smallest. The deviation is expressed by a vector norm that has three Euler angles, as elements, indicating a difference, for example, between the posture indicated by the posture information correlated with the conversion matrix and the posture of the object O detected in Step S130 by the detection unit 370, which is a posture in the imaging unit coordinate system CC. Instead of the aforementioned vector norm, the deviation may be configured to be expressed by other quantities. The conversion matrix selection unit 364 identifies a conversion matrix correlated with the identified posture information as a conversion matrix that satisfies the above condition 2).

In addition, the conversion matrix selection unit 364 calculates a difference between the redundant angle of rotation indicated by the redundant angle of rotation information stored in advance in the memory unit 32 and the redundant angle of rotation indicated by the redundant angle of rotation information correlated with each conversion matrix. The conversion matrix selection unit 364 identifies, out of the redundant angle of rotation information, redundant angle of rotation information indicating a redundant angle of rotation at which the calculated difference is the smallest. The conversion matrix selection unit 364 identifies a conversion matrix correlated with the identified redundant angle of rotation information as a conversion matrix that satisfies the above condition 3).

In addition, the conversion matrix selection unit 364 identifies a conversion matrix correlated with the pose information that coincides with the pose information stored in advance in the memory unit 32 as a conversion matrix that satisfies the above condition 4).

In this way, in Step S140, the conversion matrix selection unit 364 selects one conversion matrix that satisfies the predetermined condition out of the plurality of conversion matrices stored in the conversion matrix table as the target conversion matrix.

Next, the calculation unit 363 executes processing of calculating a first matrix that represents the position and posture of the object O detected in Step S130 by the detection unit 370 (Step S145). The position and posture of the object O are a position and posture in the imaging unit coordinate system CC. Next, based on the target conversion matrix selected in Step S140 by the conversion matrix selection unit 364, the matrix conversion unit 365 executes processing of converting the first matrix calculated in Step S145 by the calculation unit 363 to a second matrix (Step S150). Specifically, as expressed as the following Expression (3), the matrix conversion unit 365 converts the first matrix to the second matrix as a result of the target conversion matrix being multiplied by the first matrix.

^{R}T_{TCP}=^{R}T_{C}^{C}T_{TCP} (3)

Next, the robot control unit 369 designates information indicating a position represented by the second matrix converted in Step S150 as the control point position information, and designates information indicating a posture represented by the second matrix as the control point posture information. The position is the position of the object O in the robot coordinate system RC. The posture is the posture of the object O in the robot coordinate system RC. Then, the robot control unit 369 has the position and posture of the control point T coincide with the position indicated by the control point position information and the posture indicated by the control point posture information.

At this time, the robot control unit 369 calculates the angle of rotation of each of the joint J1 to the joint J7 in a case where the redundant angle of rotation coincides with the redundant angle of rotation indicated by the redundant angle of rotation information stored in advance in the memory unit 32. Specifically, since the robot control unit 369 calculates the angle of rotation, the robot control unit 369 calculates the aforementioned reference plane based on the position indicated by the control point position information, the posture indicated by the control point posture information, and first structure information stored in advance in the memory unit 32. The reference plane is a reference plane in a case where the position and posture of the control point T coincide with the position indicated by the control point position information and the posture indicated by the control point posture information. The first structure information is information indicating the structure of the arm A, including the size or shape of each member provided in a hypothetical arm A in a case where the joint J3 does not exist. The robot control unit 369 calculates the angle of rotation of each of the joint J1 to the joint J7 in a case where the angle of the target plane with respect to the reference plane, that is, the redundant angle of rotation coincides with the redundant angle of rotation indicated by the redundant angle of rotation information stored in advance in the memory unit 32. At this time, the robot control unit 369 calculates the angle of rotation based on the position indicated by the control point position information, the posture indicated by the control point posture information, the calculated reference plane, and second structure information stored in advance in the memory unit 32. At this time, the robot control unit 369 has the angle of rotation of each of the joint J2, the joint J4, and the joint J6 coincide with the angle of rotation designated in the pose information. The second structure information is information indicating the structure of the arm A, including the size and shape of each member provided in the arm A. The robot control unit 369 moves the control point T by having the calculated angle of rotation coincide with the angle of rotation of each of the joint J1 to the joint J7. Then, the robot control unit 369 causes the end effector E to grip the object O. The robot control unit 369 disposes the object O gripped by the end effector E in the material supplying region (not illustrated) based on the information indicating the position of the material supplying region stored in advance in the memory unit (Step S160), and terminates processing.

In this way, the robot control device 30 has the plurality of conversion matrices that convert the first matrix that represents the position and posture of the object O in the imaging unit coordinate system CC representing the position and posture on the image captured by the imaging unit 10 to the second matrix representing the position and posture of the object O in the robot coordinate system RC, selects one conversion matrix out of the plurality of conversion matrices as the target conversion matrix, and causes the robot 20 to perform a predetermined work based on the selected conversion matrix. Accordingly, the robot control device 30 can improve the accuracy of the work performed by the robot 20. In addition, since the robot control device 30 converts the first matrix to the second matrix based on the target conversion matrix that satisfies the predetermined condition, the robot control device 30 can have a relative positional relationship between the end effector E and the object O coincide with a positional relationship desired by the user with high accuracy when the end effector E grips the object O detected from the image captured by the imaging unit 10. As a result, the robot control device 30 is less required to cause the end effector E to adjust the grip of the end effector E on the object O, and thus can reduce the time it takes for the robot 20 to perform the work.

In addition, since the first matrix is converted to the second matrix based on the target conversion matrix that satisfies the predetermined condition, the robot control device 30 can prevent the occurrence of an error which is caused in a case where the state of the manipulator M is changed according to an environment within the work region RA when the end effector E is caused to grip the object O. The environment is an environment represented by the position and posture of the object O, other objects disposed in the vicinity of the object O, and a positional relationship between the object O and a wall. In addition, the state is a state represented by the angle of rotation of each joint of the manipulator M. The error is an error that occurs due to the rigidity of each member which configures the robot 20 and is related to the position and posture of the control point T. The error occurs each time at least one of the pose information, the redundant angle of rotation, and the posture of the control point T changes. The robot control device 30 can prevent the error by causing the robot 20 to perform the predetermined work based on the conversion matrix that satisfies the predetermined condition.

Processing in which Robot Control Device Generates Conversion Matrix

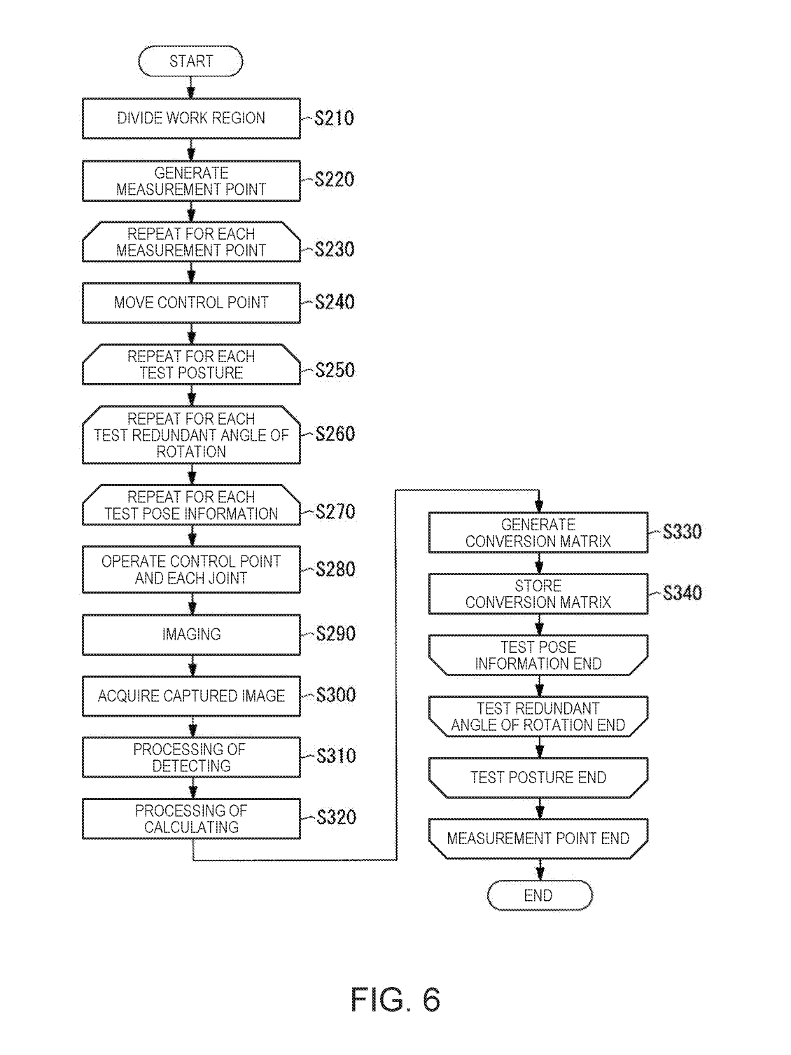

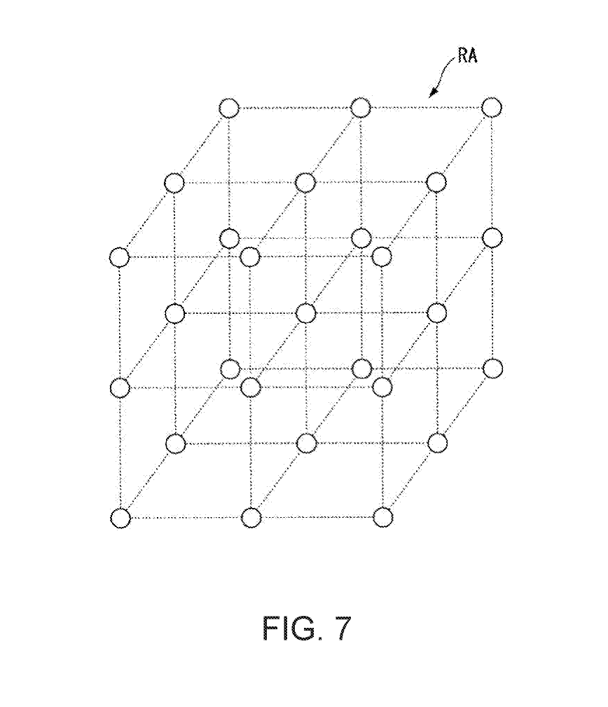

Hereinafter, processing in which the robot control device 30 generates a conversion matrix will be described with reference to FIG. 6 and FIG. 7. FIG. 6 is a flow chart illustrating an example a flow of the processing in which the robot control device 30 generates a conversion matrix. In the processing of the flowchart illustrated in FIG. 6, a case where region information indicating the work region RA is stored in advance in the memory unit 32 is described. In addition, hereinafter, a case where the work region RA is a rectangular parallelepiped region will be described. Instead of the rectangular parallelepiped shape, the shape of the work region RA may be other shapes.

The conversion matrix generation unit 367 reads, from the memory unit 32, the region information stored in advance in the memory unit 32. The conversion matrix generation unit 367 divides the work region RA indicated by the region information read from the memory unit 32 into a plurality of regions (Step S210). For example, the conversion matrix generation unit 367 divides the rectangular parallelepiped work region RA such that the cubic divided regions having the same volume are arranged without intervals in each coordinate-axis direction in the robot coordinate system RC. Instead of the cubic shape, the shape of the divided region may be other shapes. In addition, the volumes of apart of or the whole of the plurality of divided regions may be different from each other. In addition, the shapes of a part of or the whole of the plurality of divided regions may be different from each other.

Next, the conversion matrix generation unit 367 generates a plurality of measurement points according to the divided regions of the work region RA obtained in Step S210 (Step S220). The measurement point is a virtual point for having the control point T coincide with the measurement point. The measurement point is correlated with measurement point position information indicating the position of the measurement point and measurement point posture information indicating the posture of the measurement point. In this example, having the control point T coincide with the measurement point means that the position and posture of the measurement point coincide with the position and posture of the control point T. Hereinafter, a case where all of the postures of the measurement points are the same will be described as an example. Instead of the same posture, the postures of a part of or the whole of the measurement points may be different from each other.

Herein, the work region RA, which is divided into the plurality of divided regions, and the measurement point will be described with reference to FIG. 7. FIG. 7 is a view exemplifying the work region RA divided into the plurality of regions, and the measurement point. In the example illustrated in FIG. 7, the work region RA is divided into eight regions separated by dotted lines. As described above, these divided regions are cubic divided regions of which volumes are the same.

The conversion matrix generation unit 367 identifies positions at which, for example, the lines (in the example illustrated in FIG. 7, the dotted lines) separating the work region RA into the eight divided regions intersect. The conversion matrix generation unit 367 generates a virtual point at the identified position as the measurement point according to the divided region. For each generated measurement point, the conversion matrix generation unit 367 correlates the measurement point with measurement point position information indicating the position of the measurement point and measurement point posture information indicating the posture of the measurement point. Each of the postures of the plurality of measurement points may be any posture. In addition, the postures of a part of or the whole of the plurality of measurement points may be postures different from each other, or may be the same posture. In the example illustrated in FIG. 7, round marks illustrated at positions where the dotted lines intersect indicate each measurement point.

After the plurality of measurement points are generated in Step S220, each of the angle of rotation information acquisition unit 366, the conversion matrix generation unit 367, the memory control unit 368, the robot control unit 369, and the detection unit 370 repeats processing of Step S240 to Step S340 for each of the plurality of generated measurement points (Step S230).

The robot control unit 369 moves the control point T by having the control point T coincide with the measurement point selected in Step S230 (Step S240). Then, each of the angle of rotation information acquisition unit 366, the conversion matrix generation unit 367, the memory control unit 368, the robot control unit 369, and the detection unit 370 executes processing of Step S250 to Step S340 as processing of generating a conversion matrix.

After the robot control unit 369 has the control point T coincide with the measurement point selected in Step S220, the robot control unit 369 reads, from the memory unit 32, test posture information indicating a plurality of test postures stored in advance in the memory unit 32. Then, the robot control unit 369 repeats processing of Step S260 to Step S340 for each of the plurality of test postures indicated by the read test posture information (Step S250).

The plurality of test postures include, for example, each of postures obtained by the control point T in a posture to be set as a reference posture being rotated about an X-axis in the control point coordinate system TC by a first predetermined angle in the range of 0° to 360° at a time, each of postures obtained by the control point T in the posture to be set as the reference posture being rotated about a Y-axis in the control point coordinate system TC by a second predetermined angle in the range of 0° to 360° at a time, and each of postures obtained by the control point T in the posture to be set as the reference posture being rotated about a Z-axis in the control point coordinate system TC by a third predetermined angle in the range of 0° to 360° at a time. The posture to be set as the reference posture out of the postures of the control point T is, for example, a posture in which each coordinate axis of the control point coordinate system TC coincides with each coordinate axis of the robot coordinate system RC.

The first predetermined angle is, for example, 30°. Instead of 30°, the first predetermined angle may be an angle smaller than 30°, or may be an angle larger than 30° insofar as 360° can be equally divided. The second predetermined angle is, for example, 30°. In addition, instead of 30°, the second predetermined angle may be an angle smaller than 30°, or may be an angle larger than 30° insofar as 360° can be equally divided. The third predetermined angle is, for example, 30°. In addition, instead of 30°, the third predetermined angle may be an angle smaller than 30°, or may be an angle larger than 30° insofar as 360° can be equally divided.

Instead of the aforementioned posture, the posture to be set as the reference posture out of the postures of the control point T may be other postures. In addition, instead of the aforementioned postures, the plurality of test postures may be configured to include other postures. The other postures include, for example, each of postures obtained by the control point in the posture to be set as the reference posture being rotated first about the X-axis and then about the Y-axis in the control point coordinate system TC by a fourth predetermined angle in the range of 0° to 360° at a time. In this case, the fourth predetermined angle is, for example, 30°. The fourth predetermined angle may be an angle smaller than 30°, or may be an angle larger than 30°, instead of 30°, insofar as 360° can be equally divided.

After the test posture is selected in Step S250, the robot control unit 369 reads, from the memory unit 32, test redundant angle of rotation information indicating a plurality of test redundant angles of rotation stored in advance in the memory unit 32. Then, the robot control unit 369 repeats processing of Step S270 to Step S340 for each of the plurality of test redundant angles of rotation indicated by the read test redundant angle of rotation information (Step S260).

The plurality of test redundant angles of rotation include, for example, each of redundant angles of rotation at a redundant angle of rotation to be set as a reference redundant angle of rotation rotated by a fifth predetermined angle in the range of 0° to 360° at a time. The redundant angle of rotation to be set as the reference redundant angle of rotation out of the redundant angles of rotation is, for example, 0°. Instead of the aforementioned redundant angle of rotation, the redundant angle of rotation to be set as the reference redundant angle of rotation may be other redundant angles of rotation. The fifth predetermined angle is, for example, 20°. Instead of 20°, the fifth predetermined angle may be an angle smaller than 20°, or may be an angle larger than 20° insofar as 360° can be equally divided.

After the test redundant angle of rotation is selected in Step S260, the robot control unit 369 reads, from the memory unit 32, the plurality of pieces of test pose information stored in advance in the memory unit 32. Then, the robot control unit 369 repeats processing of Step S280 to Step S340 for each of the plurality of pieces of read test pose information (Step S270).

Each of the plurality of pieces of test pose information is, for example, a combination of information indicating which angle of rotation is to be set out of two angles of rotation different from each other by 180°, one being a smaller angle of rotation and the other being a larger angle of rotation, and a part of the combination of each of the information of the joint J2, the joint J4, and the joint J6, which are joints that is capable of being flipped, is different from each other.

After the test pose information is selected in Step S270, the robot control unit 369 changes the posture of the control point T to have the posture of the control point T coincide with the test posture selected in Step S250. When having the test posture coincide with the posture of the control point T, the robot control unit 369 calculates a reference plane in a case where the position and posture of the control point T coincide with the test position and the test posture. The robot control unit 369 rotates a redundant angle of rotation based on the calculated reference plane to have the test redundant angle of rotation selected in Step S260 coincide with the redundant angle of rotation. In addition, when having the posture of the control point T coincide with the test posture, the robot control unit 369 rotates the joints that is capable of being flipped based on the test pose information selected in Step S270 to have the angle of rotation of each of the joints that is capable of being flipped coincide with the angle of rotation designated in the test pose information (Step S280).

Next, the imaging control unit 361 causes the imaging unit 10 to image an area that includes the work region RA (Step S290). Next, the image acquisition unit 362 acquires, from the imaging unit 10, the image captured in Step S290 by the imaging unit 10 (Step S300). Next, the detection unit 370 executes processing of detecting the position and posture of the control point T included in the captured image acquired in Step S300 by the image acquisition unit 362 (Step S310). The position and posture are a position and posture in the imaging unit coordinate system CC. For example, the detection unit 370 detects the position and posture from the captured image by pattern matching based on the reference model of the end effector E stored in advance in the memory unit 32. The reference model of the end effector E is three-dimensional model data obtained by the three-dimensional shape, color, and pattern of the end effector E being modeled in three dimensions, and shown, for example, in computer graphics (CG). Instead of pattern matching, the detection unit 370 may be configured to detect the position and posture from the captured image by other methods, including a method in which a marker is provided on the end effector E and the position and posture are detected by means of the marker.

Next, the angle of rotation information acquisition unit 366 acquires the angle of rotation information indicating the angle of rotation of the actuator provided in each joint of the manipulator M from the encoder provided in the actuator. Then, the calculation unit 363 executes processing of calculating the position and posture of the control point T in the robot coordinate system RC based on the angle of rotation information acquired from the encoder by the angle of rotation information acquisition unit 366 and forward kinematics (Step S320). Next, the calculation unit 363 calculates a first matrix representing the position and posture of the control point T detected in Step S310, which are a position and posture in the imaging unit coordinate system CC, and a second matrix representing the position and posture of the control point T calculated in Step S320, which are a position and posture in the robot coordinate system RC. Then, the conversion matrix generation unit 367 generates a conversion matrix based on the first matrix and second matrix calculated by the calculation unit 363 and the above Expression (1) (Step S330). Next, the memory control unit 368 correlates the conversion matrix generated in Step S330 with the position information indicating the position of the measurement point selected in Step S230, the posture information indicating the test posture selected in Step S250, the redundant angle of rotation information indicating the test redundant angle of rotation selected in Step S260, and the test pose information selected in Step S270, and stores the conversion matrix in the conversion matrix table stored in the memory unit 32 (Step S340). At this time, in a case where the conversion matrix table does not exist within the memory region of the memory unit 32, the memory control unit 368 generates a conversion matrix table within the memory region.

After the processing of Step S270 to Step S340 is repeated until test pose information yet to be selected no longer exists, each of the angle of rotation information acquisition unit 366, the conversion matrix generation unit 367, the memory control unit 368, the robot control unit 369, and the detection unit 370 selects the next test redundant angle of rotation for Step S260, and the processing of Step S270 to Step S340 is performed again.

In addition, after the processing of Step S260 to Step S340 is repeated until a test redundant angle of rotation yet to be selected no longer exists, each of the angle of rotation information acquisition unit 366, the conversion matrix generation unit 367, the memory control unit 368, the robot control unit 369, and the detection unit 370 selects the next test posture for Step S250, and the processing of Step S260 to Step S340 is performed again.

In addition, after the processing of Step S250 to Step S340 is repeated until a test posture yet to be selected no longer exists, each of the angle of rotation information acquisition unit 366, the conversion matrix generation unit 367, the memory control unit 368, the robot control unit 369, and the detection unit 370 selects the next measurement point for Step S230, and the processing of Step S240 to Step S340 is performed again.

By repeating such processing, the robot control device 30 can generate the plurality of conversion matrices, in which the position information, the posture information, the redundant angle of rotation information, and the pose information are correlated with each other, as illustrated in FIG. 5. Accordingly, the robot control device 30 can improve the accuracy of the work performed by the robot based on one or more conversion matrices generated for each of the plurality of measurement points according to the divided region.

### Modification Example of Embodiment

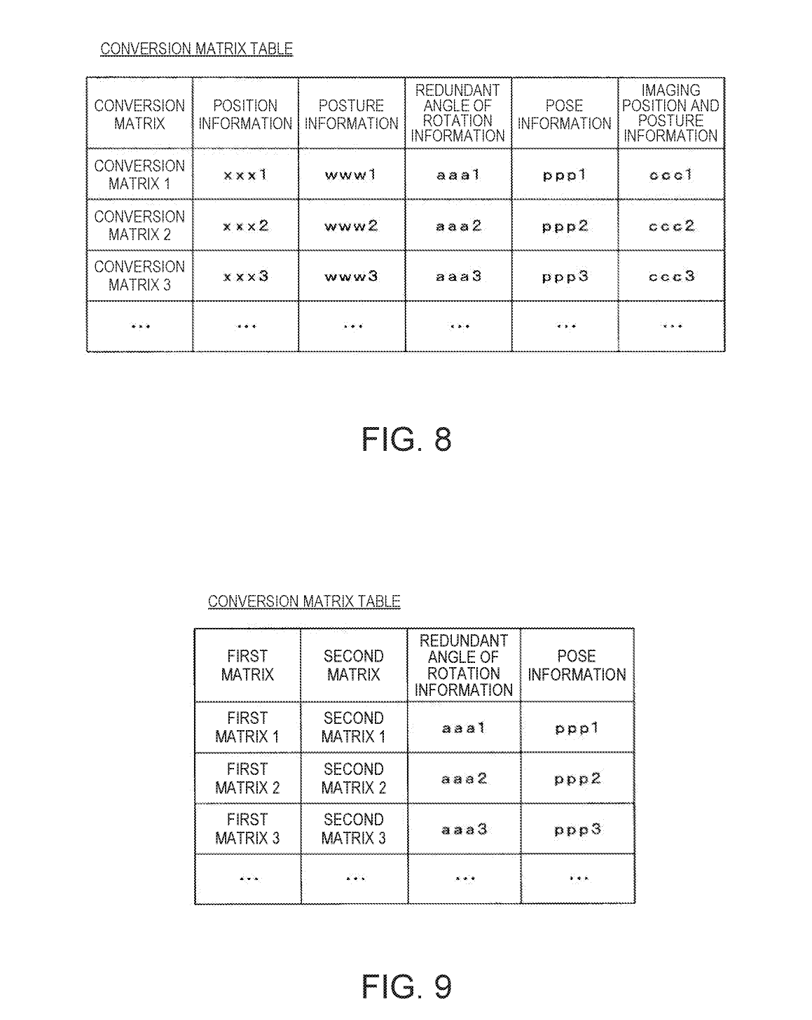

Hereinafter, a modification example of the embodiment will be described with reference to FIG. 8.

FIG. 8 is a view illustrating another example of the conversion matrix table. As illustrated in FIG. 8, imaging position and posture information indicating the position and posture of the imaging unit 10 in the robot coordinate system RC may be correlated with the conversion matrix illustrated in the embodiment. In this example, the position of the imaging unit 10 in the robot coordinate system RC is represented by the position of the centroid of the imaging unit 10. In addition, the posture of the imaging unit 10 in the robot coordinate system RC is represented by a direction in the robot coordinate system RC, which is each coordinate axis of an imaging unit posture coordinate system. The imaging unit posture coordinate system is a three-dimensional local coordinate system correlated with the position of the imaging unit 10.

In this case, the robot control device 30 executes the processing of the flow chart illustrated in FIG. 6 each time the robot control device 30 has each of a plurality of imaging unit test positions and imaging unit test postures coincide with the position and posture of the imaging unit 10 in the robot coordinate system. RC. Then, while executing the processing, the robot control device 30 correlates the imaging position and posture information indicating the imaging unit test position and imaging unit test posture of the provided imaging unit 10 with each of the conversion matrices obtained as a result of executing the processing.

When selecting a target conversion matrix out of the plurality of conversion matrices correlated with the imaging position and posture information, the robot control device 30 selects a plurality of conversion matrices correlated with imaging position and posture information indicating a position and posture that are the closest to the current position and posture of the imaging unit 10, which is information input by the user. Then, from the plurality of selected conversion matrices, the robot control device 30 selects a conversion matrix that satisfies the aforementioned predetermined condition as the target conversion matrix.

Accordingly, without newly generating a conversion matrix even in a case where the position and posture of the imaging unit 10 are changed, the robot control device 30 can improve the accuracy of the work performed by the robot based on the conversion matrix correlated with the imaging position and posture information.

### Other Modification Example of Embodiment

In the embodiment described above, the imaging unit 10 is provided in the robot system 1, which is an object other than the robot 20. Instead of the aforementioned configuration, the robot 20 may be configured to be provided with the imaging unit 10. In this case, as in the above modification example of the embodiment, imaging position and posture information is correlated with the conversion matrix.

In addition, the robot control unit 369 may be configured to repeat the processing of Step S260 to Step S340 for each of one or more of the remaining test postures in Step S250 shown in FIG. 6, excluding a test posture, with which it is impossible to have the posture of the control point T coincide, from the plurality of test postures indicated by the test posture information.

In addition, the robot control unit 369 may be configured to repeat the processing of Step S270 to Step S340 for each of one or more of the remaining test redundant angles of rotation in Step S260 shown in FIG. 6, excluding a test redundant angle of rotation with which it is impossible to have the redundant angle of rotation coincide, from the plurality of test redundant angles of rotation indicated by the test redundant angle of rotation information.

In addition, the conversion matrix described above is a conversion matrix that coverts the first matrix representing the position and posture in the imaging unit coordinate system CC to the second matrix representing the position and posture in the robot coordinate system RC. Instead of the aforementioned matrix, the conversion matrix may be a matrix that converts one matrix of matrices representing a position and posture in each of other two coordinate systems to the other matrix. For example, in a robot system provided with two robots 20, the conversion matrix may be a conversion matrix that converts a first matrix representing a position and posture in a robot coordinate system of the first robot 20 to a second matrix representing a position and posture in a robot coordinate system of the second robot 20. In this case, the robot control device 30 selects a conversion matrix that satisfies a predetermined condition from the plurality of conversion matrices, and can cause the two robots 20 to perform a cooperation work with high accuracy based on the selected conversion matrix. The cooperation work is a work in which each of the two robots 20 performs a work different from each other within the same period.

In addition, in the conversion matrix table described above, the plurality of conversion matrices are stored after being correlated with a position and posture matrix representing a position and posture, redundant angle of rotation information, and pose information. Instead of the aforementioned matrix, a plurality of first matrices and second matrices may be configured to be stored after being correlated with the redundant angle of rotation information and the pose information.

In this case, in processing of Step S330 in the flow chart shown in FIG. 6, the calculation unit 363 calculates the first matrix representing the position and posture in the imaging unit coordinate system CC, which are the position and posture of the control point T detected in Step S310, and the second matrix representing the position and posture in the robot coordinate system RC, which are the position and posture of the control point T calculated in Step S320. Then, in processing of Step S340, the conversion matrix generation unit 367 correlates the first matrix and the second matrix with the redundant angle of rotation information indicating the test redundant angle of rotation selected in Step S260 and the test pose information selected in Step S270, and stores the matrices in the conversion matrix table stored in the memory unit 32.

FIG. 9 is a view illustrating an example of the conversion matrix table storing the plurality of first matrices and second matrices correlated with the redundant angle of rotation information and the pose information. As illustrated in FIG. 9, the conversion matrix table stores the plurality of first matrices and second matrices correlated with the redundant angle of rotation information and the pose information. Within the conversion matrix table, the plurality of first matrices and second matrices are different from each other in terms of at least one of the redundant angle of rotation indicated by the redundant angle of rotation information and the pose information that are correlated with the first matrix and the second matrix. The conversion matrix table may be configured to store the first matrix and the second matrix correlated with a part of the redundant angle of rotation information and the pose information. Instead of one of or both of the redundant angle of rotation information and the pose information, the conversion matrix table may be configured to store the first matrix and the second matrix correlated with other types of information.

In a case where the conversion matrix table is the table illustrated in FIG. 9, in Step S140 of the flow chart illustrated in FIG. 4, the conversion matrix selection unit 364 reads the redundant angle of rotation information and the pose information stored in advance in the memory unit 32. Then, the conversion matrix selection unit 364 selects one record that satisfies a predetermined second condition, as a target record, from the conversion matrix table read from the memory unit 32. In this example, the predetermined second condition is a condition that satisfies all of three conditions 1A) to 3A) as follows. The predetermined second condition may have a configuration in which a part of the three conditions is required to be satisfied, or may have a configuration in which other conditions, instead of apart of or the whole of the three conditions, are required to be satisfied.

1A) A record that includes the second matrix representing the position and posture that are the closest to the position and posture of the object O detected in Step S130 by the detection unit 370. The position and posture are a position and posture in the imaging unit coordinate system CC.

2A) A record that includes the second matrix correlated with the redundant angle of rotation information indicating a redundant angle of rotation that is the closest to the redundant angle of rotation indicated by the redundant angle of rotation information stored in advance in the memory unit 32, that is the redundant angle of rotation information input in advance by the user.

3A) A record that includes the second matrix correlated with the pose information that coincides with the pose information stored in advance in the memory unit 32, that is, the pose information input in advance by the user.

After the conversion matrix selection unit 364 has selected the target record from the conversion matrix table in Step S140, the conversion matrix generation unit 367 generates a conversion matrix as the target conversion matrix based on the first matrix and the second matrix that are included in the target record and the above Expression (1). Then, in Step S150, the matrix conversion unit 365 executes processing of converting the first matrix calculated by the calculation unit 363 in Step S145 to the second matrix based on the target conversion matrix generated by the conversion matrix selection unit 364.

In this way, even in a case where the conversion matrix table is the table illustrated in FIG. 9, the robot control device 30 generates the conversion matrix that converts the first matrix which represents the position and posture of the object O in the imaging unit coordinate system CC representing the position and posture on the image captured by the imaging unit 10 to the second matrix representing the position and posture of the object O in the robot coordinate system RC. Then, the robot control device 30 performs the predetermined work based on the generated conversion matrix. Accordingly, the robot 20 can improve the accuracy of the work performed by the robot 20.

As in the above description, the robot 20 has the plurality of pieces of conversion information (in this example, the conversion matrix) for converting the first information (in this example, the first matrix) that represents the position and posture of the target object (in this example, the object O) in an imaging unit coordinate system (in this example, the imaging unit coordinate system CC) representing the position and posture on the image captured by the imaging unit (in this example, the imaging unit 10) to the second information (in this example, the second matrix) representing the position and posture of the target object in the first coordinate system (in this example, the robot coordinate system RC), and selects one conversion information, as the target conversion information, from the plurality of pieces of conversion information to perform the predetermined work based on the selected conversion information. Accordingly, the robot 20 can improve the accuracy of the work performed by the robot 20.

In addition, the robot 20 selects conversion information, in which the position indicated by the position information correlated with the conversion information and the position of the target object detected from the captured image in the imaging unit coordinate system are the closest to each other, as the target conversion information. Accordingly, the robot 20 can improve the accuracy of the work performed by the robot 20 based on the conversion information correlated with the position information.

In addition, the conversion information is also correlated with the posture information indicating the posture in the imaging unit coordinate system, and the robot 20 selects conversion information, in which the posture indicated by the posture information correlated with the conversion information and the posture of the target object detected from the captured image in the imaging unit coordinate system are the closest to each other, as the target conversion information. Accordingly, the robot 20 can improve the accuracy of the work performed by the robot 20 based on the conversion information correlated with the posture information.

In addition, the robot 20 selects conversion information, in which the redundant angle of rotation indicated by the redundant angle of rotation information correlated with the conversion information and the redundant angle of rotation input in advance are the closest to each other, as the target conversion information. Accordingly, the robot 20 can improve the accuracy of the work performed by the robot 20 based on the conversion information correlated with the redundant angle of rotation information.

In addition, the robot 20 selects conversion information, as the target conversion information, in which the pose information correlated with the conversion information coincides with the pose information input in advance. Accordingly, the robot 20 can improve the accuracy of the work performed by the robot 20 based on the conversion information correlated with the pose information.

In addition, the robot 20 divides a region in which the robot 20 performs a work (in this example, the work region RA) into the plurality of regions, and generates one or more pieces of conversion information for each of the plurality of measurement points according to the divided region.

Accordingly, the robot 20 can improve the accuracy of the work performed by the robot 20 based on one or more pieces of conversion information generated for each of the plurality of measurement points according to the divided region.

In addition, the robot 20 executes processing of generating conversion information for each measurement point after having the control point (in this example, the control point T) of the robot 20 coincide with the measurement point. Accordingly, the robot 20 can improve the accuracy of the work performed by the robot 20 based on the conversion information generated by processing of generating conversion information, which is processing executed for each measurement point.

In addition, the robot 20 executes processing of generating conversion information each time the posture of the control point in the first coordinate system is changed while maintaining the position of the control point in the first coordinate system. Accordingly, the robot 20 can improve the accuracy of the work performed by the robot based on the conversion information generated by the processing of generating conversion information for each measurement point each time the posture of the control point in the robot coordinate system is changed while maintaining the state in which the control point of the robot coincides with the measurement point.

In addition, the robot 20 executes processing of generating conversion information each time the redundant angle of rotation, which is an angle of the target plane including a triangle formed by the three swing joints being connected out of joints provided in the robot 20, with respect to the reference plane is changed while maintaining the position of the control point in the robot coordinate system. Accordingly, the robot 20 can improve the accuracy of the work performed by the robot 20 based on the conversion information generated by the processing of generating conversion information for each measurement point each time the redundant angle of rotation is changed while maintaining the state in which the control point of the robot coincides with the measurement point.

In addition, the robot 20 executes processing of generating conversion information each time, out of the joints provided in the robot, the angle of rotation of the joint that is capable of being flipped (in this example, the joint J2, the joint J4, and the joint J6), which is a joint that can have the position and posture of the control point coincide with the first position and the first posture even when the joint has anyone of two angles of rotation different from each other by 180° is changed to any one of the two angles of rotation different from each other by 180°, one being a smaller angle of rotation and the other being a larger angle of rotation. Accordingly, the robot 20 can improve the accuracy of the work performed by the robot 20 based on the conversion information generated by processing of generating conversion information for each measurement point each time the angle of rotation of the joint that is capable of being flipped is changed while maintaining the state in which the control point of the robot 20 coincides with the measurement point.

In addition, the robot 20 selects conversion information, as the target conversion information, in which the imaging position and posture indicated by the imaging position and posture information correlated with the conversion information coincide with the imaging position and posture input in advance. Accordingly, the robot 20 can improve the accuracy of the work performed by the robot 20 based on the conversion information correlated with the imaging position and posture information.

In addition, the robot 20 has the plurality of conversion matrices for converting the first matrix that represents the position and posture of the target object in the imaging unit coordinate system representing the position and posture on the image captured by the imaging unit to the second matrix representing the position and posture of the target object in the robot coordinate system (in this example, the robot coordinate system RC), and selects one conversion matrix, as the target conversion matrix, out of the plurality of conversion matrices, to perform the predetermined work based on the selected conversion matrix. Accordingly, the robot 20 can improve the accuracy of the work performed by the robot 20.

Hereinbefore, although the embodiment of the invention has been described in detail with reference to the drawings, specific configurations are not limited to the embodiment. Modifications, substitutions, and omissions may be made without departing from the spirit of the invention.

In addition, a program for realizing a function of any configuration unit in the aforementioned device (for example, the robot control device 30) may be recorded in a recording medium which can be read by a computer, and the program may be executed by a computer system reading the program. Herein the “computer system” refers to an operating system (OS) or hardware including a peripheral device. In addition, the “recording medium which can be read by a computer” refers to a portable medium including a flexible disk, a magneto-optical disk, a ROM, a compact disk (CD)-ROM and a memory device including a hard disk mounted in the computer system. The “recording medium which can be read by a computer” further refers to a recording medium that maintains a program for a certain amount of time, such as a volatile memory (RAM) inside the computer system which becomes a server or a client in a case where the program is transmitted via a network, including the Internet, or a communication circuit including a telephone line.

In addition, the program may be transmitted to other computer systems from the computer system which stores the program in the memory device or the like via a transmission medium, or via a carrier wave within the transmission medium. Herein, the “transmission medium” which transmits the program refers to a medium having a function of transmitting information, such as a network (communication network) including the Internet or a communication circuit (communication line) including a telephone line.

In addition, the program may be a program for realizing apart of the aforementioned function. Furthermore, the program may be a program that can realize the aforementioned function in combination with a program already recorded in the computer system, in other words, a differential file (differential program).

The entire disclosure of Japanese Patent Application No. 2016-059673, filed Mar. 24, 2016 is expressly incorporated by reference herein.

What is claimed is:

1. A robot system comprising:
an imaging unit;
a robot; and
a robot control device that causes the robot to have a plurality of pieces of conversion information which convert first information which represents a position and posture of a target object in an imaging unit coordinate system representing a position and posture on an image captured by the imaging unit to second information representing a position and posture of the target object in a first coordinate system, to select one conversion information, as a target conversion information, out of the plurality of pieces of conversion information, and to perform a predetermined work based on the selected conversion information.

2. The robot system according to claim 1,
wherein the conversion information is correlated with position information indicating a position in the imaging unit coordinate system, and
the conversion information, in which the position indicated by the position information correlated with the conversion information and the position of the target object in the imaging unit coordinate system detected from the captured image are the closest to each other, is selected as the target conversion information.

3. The robot system according to claim 2,
wherein the conversion information is also correlated with posture information indicating a posture in the imaging unit coordinate system, and
the conversion information, in which the posture indicated by the posture information correlated with the conversion information and the posture of the target object in the imaging unit coordinate system detected from the captured image are the closest to each other, is selected as the target conversion information.

4. The robot system according to claim 2, comprising:
seven or more joints,
wherein the conversion information is also correlated with redundant angle of rotation information indicating a redundant angle of rotation that is an angle of a target plane, which is a plane including a triangle formed by the three swing joints, out of the joints provided in the robot, being connected, with respect to a reference plane, and
the conversion information, in which the redundant angle of rotation indicated by the redundant angle of rotation information correlated with the conversion information and the redundant angle of rotation input in advance are the closest to each other, is selected as the target conversion information.

5. The robot system according to claim 2,
wherein the conversion information is also correlated with pose information indicating, out of two angles of rotation that are different from each other by 180°, one being a smaller angle of rotation and the other being a larger angle of rotation, which angle of rotation is to be set as the angle of rotation of a joint that is capable of being flipped, which is a joint capable of having a position and posture of a control point coincide with a first position and a first posture out of joints provided in the robot even when the angle of rotation thereof is any one of the two angles of rotation different from each other by 180°, and
the conversion information, in which the pose information correlated with the conversion information coincides with the pose information input in advance, is selected as the target conversion information.

6. The robot system according to claim 1,
wherein a region in which the robot performs the work is divided into a plurality of regions, and one or more pieces of the conversion information are generated for each of a plurality of measurement points according to the divided regions.

7. The robot system according to claim 6,
wherein, for each of the measurement points, processing of generating the conversion information is executed after having a control point of the robot coincide with the measurement point.

8. The robot system according to claim 7,
wherein the processing is processing of generating the conversion information each time a posture of the control point in the first coordinate system is changed while maintaining a position of the control point of the robot in the first coordinate system.

9. The robot system according to claim 7, comprising:
seven or more joints,
wherein the processing is processing of generating the conversion information each time a redundant angle of rotation that is an angle of a target plane is changed, which is a plane including a triangle formed by the three swing joints out of the joints provided in the robot being connected, with respect to a reference plane while maintaining a position of the control point in the first coordinate system.

10. The robot system according to claim 7,
wherein the processing is processing of generating the conversion information each time an angle of rotation of a joint that is capable of being flipped, out of joints provided in the robot, which is a joint capable of having a position and posture of the control point coincide with a first position and a first posture even when the angle of rotation thereof is any one of two angles of rotation different from each other by 180°, is changed to any one of the two angles of rotation that are different from each other by 180°, one being a smaller angle of rotation and the other being a larger angle of rotation, while maintaining the position of the control point in the first coordinate system.

11. The robot system according to claim 2,
wherein the conversion information is also correlated with imaging position and posture information indicating an imaging position and posture, which are a position and posture of the imaging unit in the first coordinate system, and the conversion information, in which the imaging position and posture indicated by the imaging position and posture information correlated with the conversion information coincide with the imaging position and posture input in advance, is selected as the target conversion information.

12. The robot system according to claim 1,
wherein the first information is a first matrix,
the second information is a second matrix,
the conversion information is a conversion matrix, and the first coordinate system is a robot coordinate system.

13. A robot control device comprising:
a memory unit that stores a plurality of pieces of conversion information which convert first information which represents a position and posture of a target object in an imaging unit coordinate system representing a position and posture on an image captured by an imaging unit to second information representing a position and posture of the target object in a first coordinate system,
a conversion matrix selection unit that selects one conversion information, as a target conversion information, out of the plurality of pieces of conversion information, a robot control unit that performs a predetermined work based on the selected conversion information.

14. A robot comprising:
a memory unit that stores a plurality of pieces of conversion information which convert first information which represents a position and posture of a target object in an imaging unit coordinate system representing a position and posture on an image captured by an imaging unit to second information representing a position and posture of the target object in a first coordinate system,
a conversion matrix selection unit that selects one conversion information, as a target conversion information, out of the plurality of pieces of conversion information,
a robot control unit that performs a predetermined work based on the selected conversion information.
